(19) United States
(12) Patent Application Publication
(10) Pub. No.: US 2017/0079248 A1
(43) Pub. Date: Mar. 23, 2017

(54) LIGHTWEIGHT ALUMINUM LIVESTOCK CAGE

(71) Applicants: Kenneth P. Roostee, Alpharetta, GA (US); Jerry B. Ward, Alpharetta, GA (US); Bruce A. Hagenau, Brookhaven, GA (US); Charles E. Langford, Culloden, GA (US)

(72) Inventors: Kenneth P. Roostee, Alpharetta, GA (US); Jerry B. Ward, Alpharetta, GA (US); Bruce A. Hagenau, Brookhaven, GA (US); Charles E. Langford, Culloden, GA (US)

(21) Appl. No.: 15/266,714

(22) Filed: Sep. 15, 2016

Related U.S. Application Data
(60) Provisional application No. 62/220,734, filed on Sep. 18, 2015.

(51) Int. Cl. A01K 31/00; A01K 31/20; A01K 31/10

(52) U.S. Cl. CPC A01K 31/005; A01K 31/10; A01K 31/20

(57) ABSTRACT

A livestock cage may have a frame, a generally planar aluminum top sheet attached to the frame, a generally planar aluminum bottom sheet attached to the frame opposite the top sheet, a first and a second generally planar aluminum side sheet attached to the frame extending transverse to the top sheet and the bottom sheet, and a generally planar back sheet attached to the frame and transverse to the top sheet, the first side sheet, the second side sheet, and the bottom sheet. The top sheet, the bottom sheet, the first side sheet, the second side sheet, a front, and the back sheet define an interior volume of the cage. A plurality of livestock is within the interior of the cage.

### CROSS-REFERENCE TO RELATED APPLICATIONS

The present application claims the benefit of U.S. provisional patent application Ser. No. 62/220,734, filed on Sep. 18, 2015, and entitled “Lightweight Aluminum Poultry Cage,” the entire disclosure of which is hereby incorporated by reference as if set forth verbatim herein and relied upon for all purposes.

### TECHNICAL FIELD

Example embodiments generally relate to livestock cages and more particularly to lightweight aluminum livestock cages.

### BACKGROUND

Poultry cages are frequently made of galvanized steel frames and components and utilize wire for the sides of the cages for airflow. The weight of steel, however, can limit the number and size of cages that may be loaded on a trailer in view of trailer and total truck weight restrictions. Additionally, the wire sides can allow birds to extend wings and/or feet therethrough, creating the possibility of injury to the birds being transported in the cages. Further, the components of steel cages are assembled by welding.

It is also known to construct poultry cages using a combination of aluminum and polymer components. While these cages are generally lighter than steel cages, these cages are also constructed in such a way that can allow birds to extend wings through the cage to the exterior, creating the possibility of injury to the bird. Moreover, the aluminum and polymer components are connected by a spline/slot construction that limits the components' ability to contribute structural rigidity.

### SUMMARY

Some example embodiments may provide poultry cages. In particular, some example embodiments may provide a lightweight aluminum poultry cage that provides, for example, improved light and heat reflection, increased transport efficiency, improved repairability, decreased risk of injury to birds in transport, and decreased visibility to the birds from the cage exterior.

In an example embodiment, a lightweight aluminum livestock cage may include an aluminum cage frame, an aluminum top sheet, an aluminum bottom floor pan, at least two aluminum side sheets, an aluminum back sheet, an aluminum center sheet, and a plurality of aluminum intermediate floor pans. The aluminum cage frame, the aluminum top sheet, the aluminum bottom floor pan, the at least two aluminum side sheets, the aluminum back sheet, the aluminum center sheet, and the plurality of aluminum intermediate floor pans may be attached with a plurality of screws. Moreover, it should be understood that the term “screws” is inclusive of a variety of different mechanical fasteners including, but not limited to, screws, nuts, bolts, rivets, rivnuts, and inserts. In addition, the aluminum top sheet, the aluminum bottom floor pan, and the plurality of aluminum intermediate floor pans may comprise solid aluminum sheets. Moreover, the at least two aluminum side sheets, the aluminum back sheet, and the aluminum center sheet may comprise perforated patterned aluminum sheets.

In an example embodiment, a livestock cage includes a frame, and a generally planar aluminum top sheet attached to the frame, thereby defining a top surface of the cage. A generally planar aluminum bottom sheet attaches to the frame opposite the top surface of the cage, thereby defining a bottom surface of the cage. A first generally planar aluminum side sheet attaches to the frame, extending transverse to the top sheet from a first edge of the top sheet to a first edge of the bottom sheet, thereby defining a first side surface of the cage. A second generally planar aluminum side sheet attaches to the frame opposite the first side surface of the cage, thereby defining a second side surface of the cage. Front edges of the top sheet, the bottom sheet, the first side sheet, and the second side sheet define a front of the cage. A generally planar back sheet attaches to the frame opposite the front and transverse to the top sheet, the first side sheet, the second side sheet, and the bottom sheet. The top sheet, the bottom sheet, the first side sheet, the second side sheet, the front, and the back sheet define an interior volume of the cage. A plurality of livestock is within the interior of the cage. At least one of the first side sheet, the second side sheet, and the back sheet has a plurality of holes therethrough.

In a still further embodiment, a livestock cage has a frame, a generally planar aluminum top sheet attached to the frame, thereby defining a top surface of the cage, and a generally planar aluminum bottom sheet attached to the frame opposite the top surface of the cage via a plurality of rivets so that a head of each rivet is approximately flush with a top surface of the bottom sheet, thereby defining a bottom surface of the cage. A first generally planar aluminum side sheet is attached to the frame extending transverse to the top sheet from a first edge of the top sheet to a first edge of the bottom sheet, thereby defining a first side surface of the cage. A second generally planar aluminum side sheet is attached to the frame opposite the first side surface of the cage, thereby defining a second side surface of the cage. Front edges of the top sheet, the bottom sheet, the first side sheet, and the second side sheet define a front of the cage. A generally planar back sheet is attached to the frame opposite the front and transverse to the top sheet, the first side sheet, the second side sheet, and the bottom sheet. The top sheet, the bottom sheet, the first side sheet, the second side sheet, the front, and the back sheet define an interior volume of the cage. A plurality of livestock is within the interior of the cage, At least one of the first side sheet, the second side sheet, and the back sheet comprises a plurality of holes therethrough.

### BRIEF DESCRIPTION OF THE SEVERAL VIEWS OF THE DRAWING(S)

Aspects of the present invention can be better understood with reference to the following drawings. The components in the drawings are not necessarily to scale. An enabling disclosure of the present invention, including the best mode thereof, is set forth in the specification, which makes reference to the appended drawings, in which:

FIG. 1 illustrates a top perspective view of a poultry or other livestock cage according to an example embodiment;

FIG. 2 illustrates a front perspective view of a cage according to an example embodiment;

FIG. 3 illustrates a partial bottom perspective view of the cage as in FIG. 1;

FIG. 4 illustrates a partial bottom perspective view of the cage as in FIG. 1;

FIG. 5 illustrates a partial bottom perspective view of the cage as in FIG. 1;

FIG. 6 illustrates a top schematic view of the cage as in FIG. 1;

FIG. 7 illustrates a back schematic view of the cage as in FIG. 1;

FIG. 8 illustrates a back perspective view of the cage as in FIG. 1;

FIG. 9 illustrates a side schematic view of the cage as in FIG. 1;

FIG. 10 illustrates a side perspective view of the cage as in FIG. 2;

FIG. 11 illustrates a top perspective view of a cage according to an example embodiment, with one bottom door of a plurality of doors shown;

FIG. 12 illustrates a front schematic view of the cage as in FIG. 11, with complete set of closed doors and detail of a corner thereof;

FIG. 13 illustrates a partial bottom perspective view of the cage as in FIG. 11;

FIG. 14 illustrates a partial bottom perspective view of the cage as in FIG. 11;

FIG. 15 illustrates a partial bottom perspective view of the cage as in FIG. 11;

FIG. 16 illustrates a top schematic view of the cage as in FIG. 11;

FIG. 17 illustrates a front perspective view of the cage as in FIG. 11, with a complete set of closed doors;

FIG. 18 illustrates a back schematic view of the cage as in FIG. 11;

FIG. 19 illustrates a side schematic view of the cage as in FIG. 11; and

FIG. 20 illustrates a bottom perspective view of the cage as in FIG. 11.

Repeat use of reference characters in the present specification and drawings is intended to represent same or analogous features or elements of embodiments of the present invention.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Like reference numerals refer to like elements throughout. As used in the specification, the singular forms “a,” “an,” “the,” include plural referents unless the context clearly dictates otherwise. Furthermore, as used herein, the term “or” is to be interpreted as a logical operator that results in true whenever one or more of its operands are true. Moreover, although chickens are frequently referenced throughout this disclosure, chickens serve only as an example of poultry for which the lightweight aluminum poultry cage may be used.

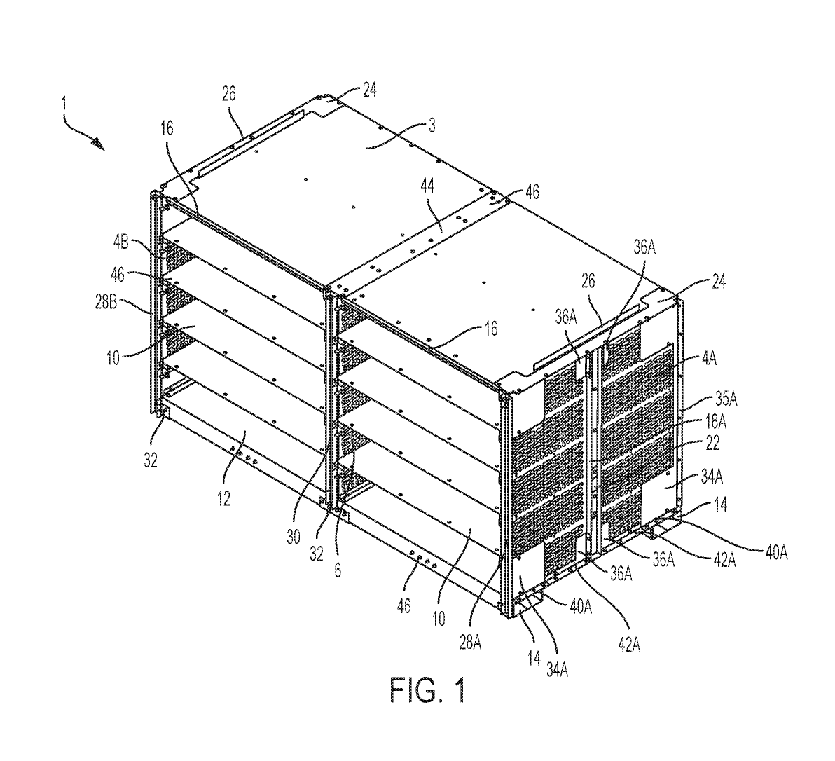

As used herein, terms referring to a direction or a position relative to the orientation of the poultry cage, such as but not limited to “vertical,” “horizontal,” “upper,” “lower,” “above,” or “below,” refer to directions and relative positions with respect to the cage's orientation in its normal intended operation, as indicated, e.g. in FIGS. 1, 2, 7-12, and 17-20 herein. Thus, for instance, the terms “vertical” and “upper” refer to the vertical direction and relative upper position in the perspectives of the Figures and should be understood in that context, even with respect to a cage that may be disposed in a different orientation.

Some example embodiments may improve light and heat reflection, increase transport efficiency, improve repairability, and decrease the possibility of injury to birds during transport. In this regard, some example embodiments may provide lightweight aluminum poultry cages for transporting chickens or other poultry having an aluminum cage frame, an aluminum top sheet, an aluminum bottom floor pan, at least two aluminum side sheets, an aluminum back sheet, an aluminum center sheet, and a plurality of aluminum intermediate floor pans. The aluminum cage frame, the aluminum top sheet, the aluminum bottom floor pan, the at least two aluminum side sheets, the aluminum back sheet, the aluminum center sheet, and the plurality of aluminum intermediate floor pans may be attached with a plurality of screws. In addition, the aluminum top sheet, the aluminum bottom floor pan, and the plurality of aluminum intermediate floor pans may comprise solid aluminum sheets. Moreover, the at least two aluminum side sheets, the aluminum back sheet, and the aluminum center sheet may comprise perforated patterned aluminum sheets.

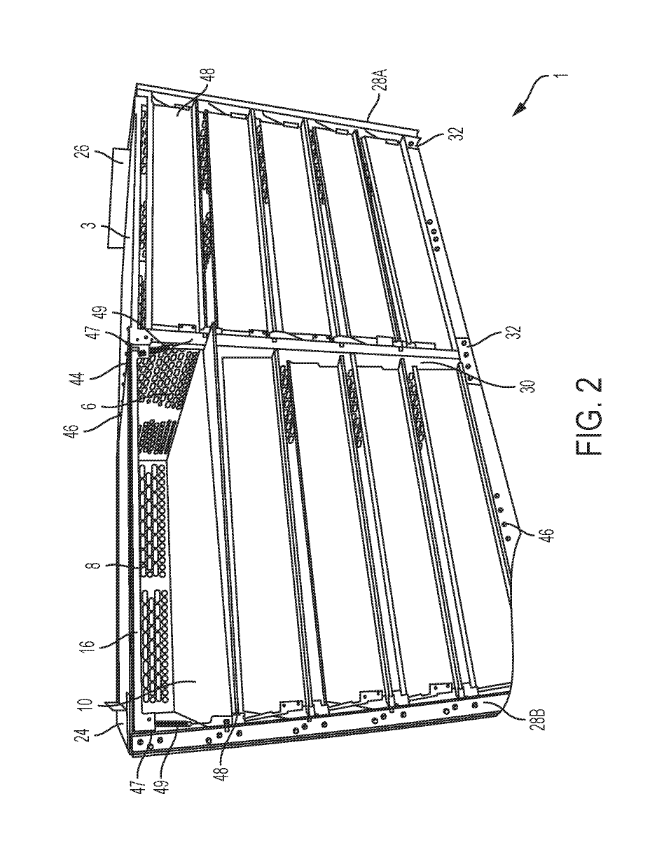

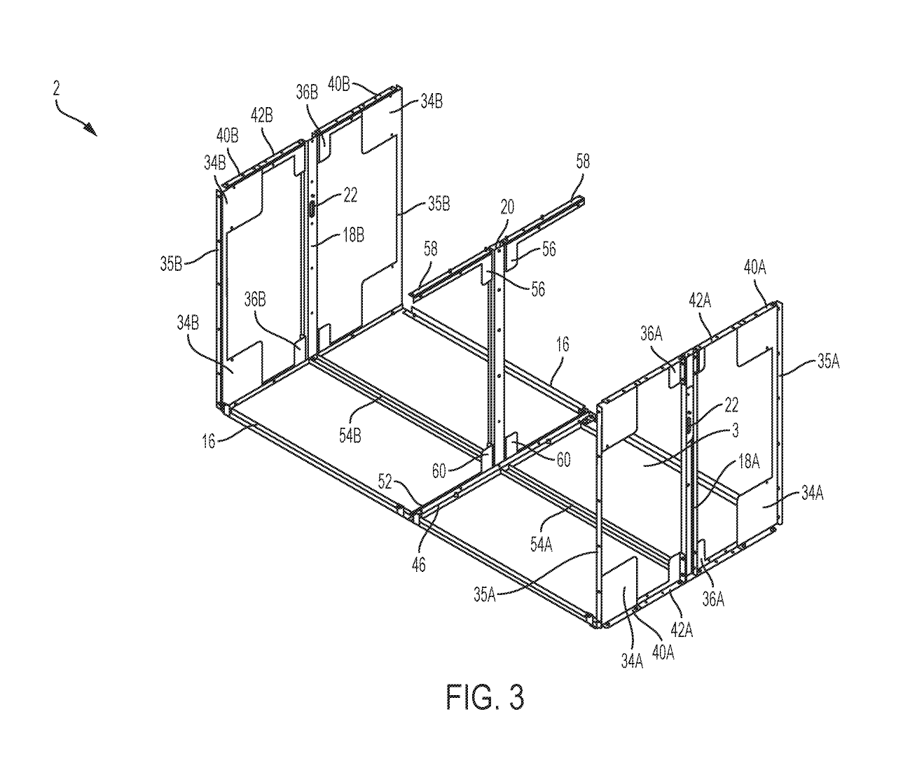

FIG. 1 illustrates a top perspective view of a poultry cage according to an example embodiment, in which aluminum is used to construct a poultry or other livestock cage 1. In some example embodiments, every structural component of poultry cage 1 (e.g., cage frame 2, back sheet 8, intermediate floor pans 10, etc., as shown in FIGS. 2 and 3) may comprise aluminum, and in some embodiments entirely consist of aluminum. In this regard, poultry cage 1 may be lightweight, and in the embodiments described herein approximately half the weight of a comparable steel cage, and thereby a greater number and/or size of cages may be loaded onto a single trailer while staying within trailer and total truck weight requirements. In certain example embodiments, up to 30% more birds may be transported on a single trailer while staying within trailer and total truck weight requirements. This increase in bird transport capacity results from an increase in the number of bird enclosures per trailer, rather than from an increase in the density of birds per enclosure. Moreover, by being completely constructed from aluminum, poultry cage 1 may reflect light and/or heat better than poultry cages constructed from other materials (e.g., steel, polymer, etc.) that absorb energy, i.e. light and heat, more readily than does aluminum. Aluminum also disperses absorbed heat more efficiently than does steel. In view of this weight difference, poultry cage 1 may utilize a greater amount of material than is used in cages of heavier material, such as steel, thereby e.g. allowing greater use of material in the sides and back of cage 1 to provide a greater visual and physical barrier between the cage exterior and interior, while cage 1 nonetheless has a lighter weight than the heavier-material cages of comparable dimensions. In this regard, poultry cage 1 prevents the birds from extending wings or feet through the cage walls to the exterior, thereby decreasing risk of injury to the birds during transport, and blocks view of birds within the cage from the cage exterior.

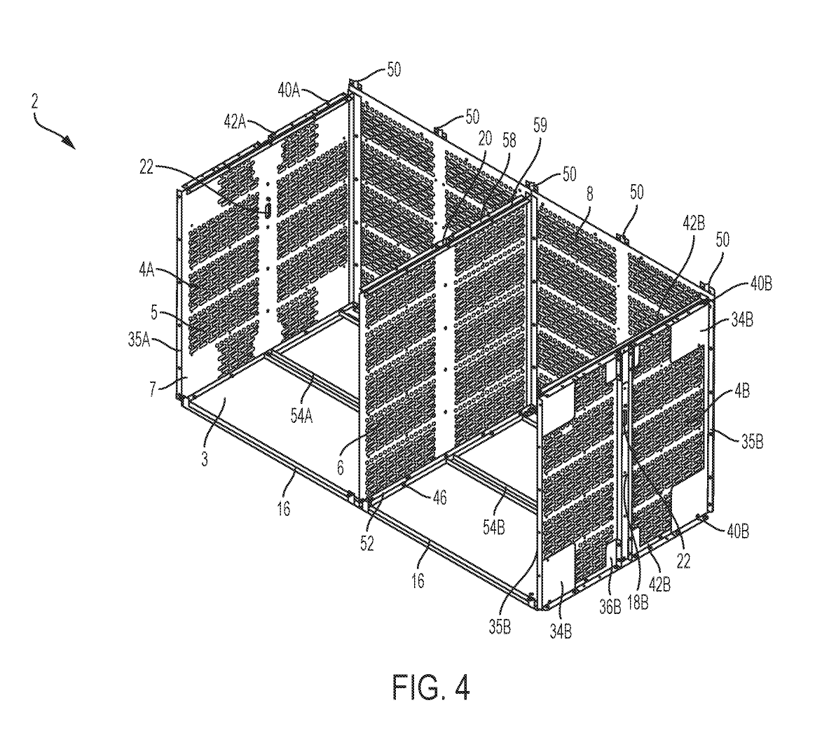

As shown in FIG. 1, poultry cage 1 may include a top sheet 3 positioned atop side sheets 4A, 4B, center sheet 6, and back sheet 8 (FIGS. 3 and 4). Similarly, a bottom floor pan 12 may be positioned below side sheets 4A, 4B, center sheet 6, and back sheet 8. Top sheet 3, side sheets 4A, 4B, center sheet 6, and back sheet 8 may be positioned within and attached to a cage frame 2 (FIG. 3) via a plurality of screws 46. Cage frame 2 is discussed in more detail below. Both top sheet 3 and bottom floor pan 12 may be attached to side sheets 4A, 4B, center sheet 6, and back sheet 8 via screws 46. In this regard, in certain example embodiments and as shown in FIG. 1, center sheet 6 may divide poultry cage 1 into two compartments, one compartment being defined by top sheet 3, bottom floor pan 12, side sheet 4A, and center sheet 6, and the other compartment being defined by top sheet 3, bottom floor pan 12, side sheet 4B, and center sheet 6. Although FIG. 1 illustrates poultry cage 1 as being divided in half by center sheet 6, it should be understood that poultry cage 1 is not limited to having only one center sheet, and in some example embodiments, poultry cage 1 may comprise a plurality of center sheets 6 that divide poultry cage 1 into a further plurality of compartments.

Poultry cage 1 may also include a plurality of intermediate floor pans 10 vertically spaced between the bottom floor pan 12 and the top sheet 3. The plurality of intermediate floor pans 10 may extend between center sheet 6 and either side sheet 4A or 4B in one direction (i.e. parallel to back sheet 8) and between back sheet 8 and door 48 (FIG. 2) in another direction (i.e. perpendicular to back sheet 8). Intermediate floor pans 10, in combination with the side sheets, center sheet(s), back sheet(s), and doors (described below), further segment cage 1 and the compartments into sub-cages.

As illustrated by FIG. 2, bottom floor pan 12 (FIG. 1) and the plurality of intermediate floor pans 10 may each have a smooth and uninterrupted top surface. In this regard, floor pans 10, 12 may prevent birds stored within the cage from catching their feet in gaps or irregularities that might otherwise exist in a floor. Moreover, the smooth floor pans 10, 12 may enable birds housed within poultry cage 1 to easily slide to the front of poultry cage 1 within the sub-cages when the poultry cage 1 is tilted forward (i.e. front or door-side down) upon arrival at a processing plant. As shown in FIG. 2, poultry cage 1 may include a plurality of doors 48, with each door 48 pivotally attached to an intermediate floor pan 10 or the bottom floor pan 12 via one or more hinges. During transport of the poultry cage 1, each door 48 may be held closed via two spring-biased detent mechanisms 47 housed in the hinge or the cage frame on opposing sides of an opening to the respective sub-cage volume in which the door is disposed so that the detents exert a resistance force on the opposing door sides, e.g. in corresponding depressions formed in the door sides to receive the detent members. As discussed above, however, when poultry cage 1 is tilted forward at a processing plant, chickens may slide along the smooth floor pans 10, 12 towards the door 48. When pressure thereby applied by the birds to door 48 reaches a threshold level established by the resistance force applied by resilient detent 47 to the door, i.e. when the bird weight force overcomes the resistance force, the spring-biased detents 47 retract and thereby release their hold on the door, allowing the door to rotate downwardly about the hinge(s) about 90°, so that the plane of the door aligns coplanar with the plane of its respective floor pan 10 or 12. Due to the cage's forward tilt, the birds slide across the coplanar floor pan 10 or 12 and door 48 and out of the cage, thereby automatically unloading the chickens for processing. When door 48 is in its open position, respective wire struts 49 hold the door in its 90° open position, coplanar with its respective floor pan 10 or 12.

As mentioned above, top sheet 3, side sheets 4A, 4B, center sheet 6, and back sheet 8 (FIGS. 1 and 2) may be positioned within and attached to cage frame 2 via screws 46. FIG. 3 illustrates a top perspective view of a frame of the poultry cages as in FIGS. 1 and 2 positioned upside down. As shown in FIG. 3, assembly of poultry cage 1 may begin by attaching cage frame 2 to the bottom surface of top sheet 3 by attaching top sheet 3 by screws to top support flanges 16, which have an L-shaped cross section so that they may be attached by screws both to the top sheet and (in the back) to back sheet 8 which is disposed in a plane at 90° to the plane of top sheet 3. After attaching top sheet 3 to cage frame 2, for example, an upper transverse support member 52 may extend across the width of top sheet 3 at the center of top sheet 3 and may be attached to the bottom surface of top sheet 3 via a plurality of screws 46. In some example embodiments, upper transverse support member 52 may comprise a pinched rib geometry, and upper longitudinal support members 54A, 54B may comprise an elongated U-shape, to provide rigidity and additional screw surfaces to poultry cage 1. However, it should also be understood that upper transverse support member 52 and upper longitudinal support members 54A, 54B may comprise any geometry sufficient to provide additional rigidity to top sheet 3 and, more generally, to poultry cage 1. In general, though not in limitation, cage 1 includes multiple elongated support members used to support a corresponding planar aluminum member, where the elongated support member has a rigid member that extends in a plane perpendicular to the planar supported member, thereby providing additional rigidity to the planar aluminum member against bending about an axis perpendicular to the elongated member's longitudinal direction.

In certain example embodiments, cage frame 2 may include side structural posts 18A, 18B positioned adjacent respective upper longitudinal support members 54A, 54B, at ends thereof, such that each side structural post 18A and 18B forms a right angle with respect to its corresponding longitudinal support member 54A and 54B. Side structural posts 18A, 18B are load supporting members, receiving forces applied by the cage structure itself, by additional cage(s) that may be stacked upon the cage, and/or by retention straps holding the cage onto the trailer, and each side structural post 18A, 18B may comprise an elongated U-shape cross-section to provide structural rigidity to the sides of cage frame 2. Side structural posts 18A, 18B may vary in configuration but should have sufficient structural rigidity to inhibit deformation of the cage's geometry. Side structural posts 18A, 18B may also comprise a strap receiving member with an aperture 22 at which restraining straps may be attached to thereby secure poultry cage 1 to other cages and the trailer during transport. Strap receiving member/aperture 22 is discussed in more detail below.

In addition to side structural posts 18A, 18B, cage frame 2 may comprise U-shaped side support panels 34A, 34B and L-shaped side support panels 36A, 36B. For example, each side of cage frame 2 may include two U-shaped side support panels 34A of 34B, thereby providing cage frame 2 with a total of four U-shaped side support panels. Similarly, for instance, each side of cage frame 2 may include four L-shaped side support panels 36A or 36B, thereby providing cage frame 2 with a total of eight L-shaped side support panels. Both U-shaped side support panels 34A, 34B and L-shaped side support panels 36A, 36B may provide additional support to side sheets 4A, 4B and support the stiffness of cage 1 generally. U-shaped side support panels 34A, 34B each forms a main generally planar portion comprised of two large square portions connected by a narrower strip, but each also comprises a portion 35A or 35B that bends 90° to form a flange extending in a plane 90° offset from the main plane to thereby increase the structural rigidity of its corresponding support panel 34A or 34B and, thereby, the corresponding side of cage 1. Elongated side attachment flanges 35A, 35B may also provide additional surfaces for attaching back sheet 8 on the back side of poultry cage 1 and attaching front corner posts 28A, 28B (FIGS. 1 and 2) and front center post 30 (FIG. 2) on the front side of poultry cage 1 via screws 46. Each large square portion of U-shaped side support panels 34A, 34B may also bend 90° into an additional exterior side attachment flange 40A, 40B (90° with respect to flanges 35A, 35B), which may provide rigidity support and additional screw surfaces at the top and bottom of poultry cage 1 and, specifically, a surface for screw attachment to bottom floor pan 12 (FIG. 1). Similarly, L-shaped side support panels 36A, 36B each forms a main generally planar portion comprising a single large (but smaller than those of U-shaped panels 34A, 34B) square portion and a narrower strip extending from the square portion, but each also comprises a portion 42A or 42B that bends 90° to form a flange extending in a plane extending 90° offset from the main plane to thereby increase the structural rigidity of its corresponding support panel 36A, 36B. Portions 42A, 42B also provide surfaces for attachment to bottom floor pan 12 on the bottom of poultry cage 1 by a plurality of screws.

Moreover, in addition to side structural posts 18A, 18B, in some example embodiments, cage frame 2 may include a center structural post 20. One end of center structural post 20 may be attached to the bottom surface of top sheet 3 and may extend longitudinally in a direction perpendicular to top sheet 3. In certain example embodiments, center structural post 20 may be a load supporting member and, as such, may also comprise an elongated U-shape cross-section, although it should be understood that center structural post 20 may have any suitable geometry for supporting poultry cage 1. In addition to center structural post 20, the center of cage frame 2 may include L-shaped bottom support panels 56 and L-shaped top support panels 60 attached at the bottom and top of center structural post 20, respectively, into corresponding slots formed by the U-shaped configuration of post 20 on its opposing sides. Specifically, L-shaped bottom support panels 56 may be attached by screws to the bottom of center structural post 20 (to the side parts of the U-shaped post cross-section) and may also include bottom support flanges 58 bending 90° from the main planar portion of the support panels, which may provide additional surfaces on which to attach the bottom floor pan 12 (FIG. 1) by screws. L-shaped top support panels 60 attach to into both the top of center structural post 20 and upper transverse support member 52 by screws. By including these various support members, screw surfaces and/or the like throughout cage frame 2, cage frame 2 may provide sufficient rigidity and support to aluminum poultry cage 1.

FIG. 4 illustrates a top perspective view of cage frame 2 of FIG. 3, with side sheets 4A, 4B, center sheet 6, and back sheet 8 in place and with the cage positioned upside down. As shown in FIG. 4, for a poultry cage 1 having five discrete sub-cages in each half portion compartment of the main cage structure (known as a “five high” cage), for instance, side sheets 4A, 4B, center sheet 6, and back sheet 8 may each comprise a continuous aluminum sheet. However, in some example embodiments, back sheet 8 may comprise one continuous aluminum sheet, while side sheets 4A, 4B and center sheet 6 each may comprise at least two discrete aluminum sheets. In other example embodiments, comprising a six-high poultry cage 1, for instance, each of side sheets 4A, 4B, center sheet 6, and back sheet 8 may comprise at least two coplanar aluminum sheets.

Moreover, as shown in FIG. 4, side sheets 4A, 4B may be attached to side structural posts 18A, 18B by screws and structurally supported by U-shaped side support panels 34A, 34B and L-shaped side support panels 36A, 36B. Center sheet 6 may be attached to center structural post 20, the pinched rib of upper transverse support member 52 at the top of poultry cage 1, and bottom support flange 58 and lower transverse support member 59 at the bottom of poultry cage 1, by screws. Back sheet 8 may attach to cage frame 2 by screws extending into elongated side attachment flanges 35A, 35B on the sides and into top support flanges 16 at the top of cage frame 2. In addition, a plurality of back support members 50 may be attached to back sheet 8 by screws. Each of the back support members is formed with a center pinched rib that extends in a plane 90° with respect to the plane of back sheet 8 in order to provide additional rigidity to the corners and back of poultry cage 1 against bending about an axis perpendicular to the length of the back support member. Moreover, the plurality of back support members 50 may provide screw surfaces on either side of the rib for attaching the bottom floor pan 12 (FIG. 1) to poultry cage 1. As such, the plurality of back support members 50 may comprise a pinched ridge geometry to provide additional rigidity to the lightweight aluminum of back sheet 8.

As indicated above, bottom floor pan 12 (FIG. 1) rests upon (and beneath, when the cage is in its normal, upright position) exterior side attachment flanges 40A, 40B of support panels 34A, 34B, and also upon bottom support flanges 58 of bottom support panels 56. In these embodiments, rivets are inserted through flanges 40A, 40B, and 58, into bottom floor pan 12, and through the bodies of one or more U-shaped support members (not shown) that may be provided under the floor pan (in some embodiments, but not in others) and/or the channels of forklift receiving members 14 (FIG. 1). This leaves a nearly flush head of the rivet on the upper floor surface, which is insufficient to establish a pinch point for birds within the cage. Similarly, the long edges defined by flanges 40A, 40B, and 58 at the upper surface of bottom pan 12 are sufficiently low-profile and uniform that they also do not establish pinch points. Rivets may also be used to attach 90° (downward) flanges extending below and about the perimeter of bottom floor pan 12 to back support members 50.

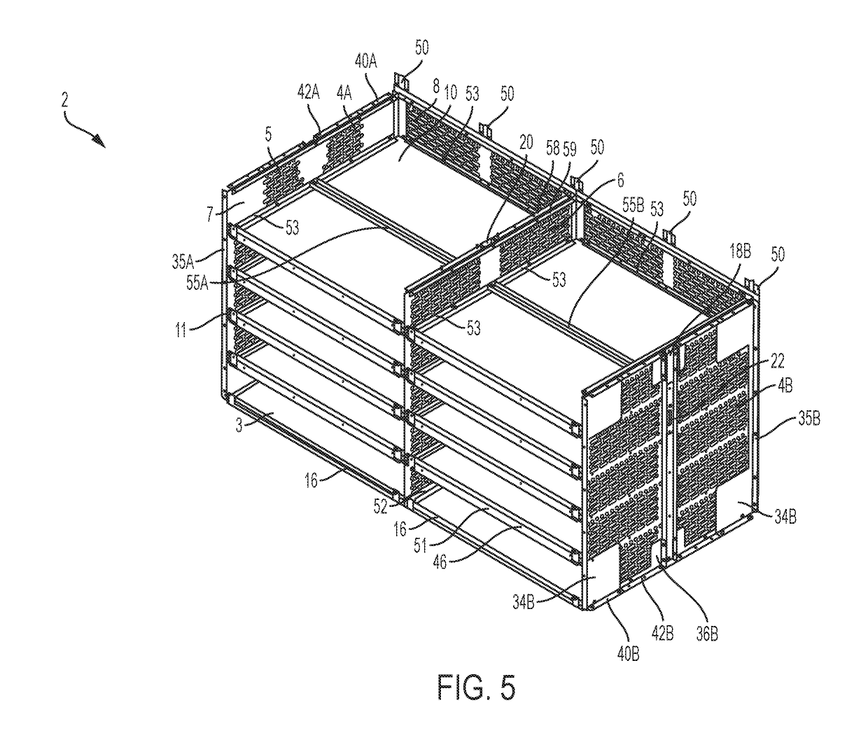

After attaching side sheets 4A, 4B, center sheet 6, and back sheet 8 to cage frame 2, intermediate floor pans 10 (FIG. 5) may be installed. As shown in FIG. 5, intermediate floor pans 10 may be attached to poultry cage 1 so as to provide even spacing between each of the intermediate floor pans 10 and define the discrete sub-cage volumes. Intermediate floor pans 10 may be attached to poultry cage 1 via a plurality of floor pan attachment members 11 by screws. For example, as shown in FIG. 5, each intermediate floor pan 10 may be attached to side sheets 4A, 4B and center sheet 6 by screws extending through the floor pan and a floor pan attachment member 11 on each side of the front of intermediate floor pan 10. In addition, each intermediate floor pan 10 may be supported by a lower longitudinal support member 55A or 55B, which, similar to upper longitudinal support members 54A, 54B (FIG. 3), may comprise an elongated U-shape cross-section to provide rigidity and additional screw surfaces to poultry cage 1. Moreover, a door attachment member 51 may be attached to each intermediate floor pan 10 by screws to enable each door 48 to attach to the frame by hinges attached to the door attachment member 51 to thereby allow the door to hinge downward to become even with a floor pan 10, 12 as discussed above. In addition, each floor pan, at each of its straight, rectangular edges, has a flange 53 that bends downward (upward, in the view of FIG. 5), thereby forming a flange that can attach by screws to an opposing side panel 4A or 4B, or back panel 8, or door attachment member 51. By bending 90° down, instead of up, the flanges avoid creating pinch points on the floor pan floor upon which birds housed within the sub-cages rest during transit.

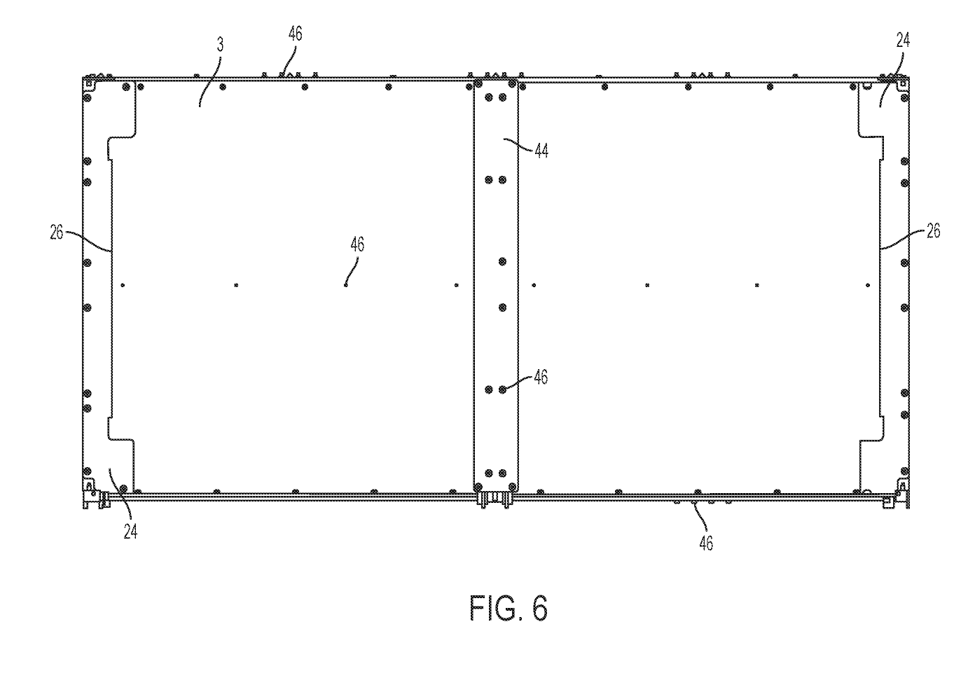

FIG. 6 illustrates a top view of the poultry cage as shown in FIGS. 1 and 2. As shown in FIG. 6, various support panels and attachments may be attached to top sheet 3 by a plurality of screws. For example, top attachment panel 44 may be a flat aluminum panel attached to the top of top sheet 3 in order to provide additional rigidity to poultry cage 1 in addition to another attachment surface for poultry cage 1. U-shaped top attachment panels 24 may also be attached to top sheet 3 for similar purposes. U-shaped top attachment panels 24 also may provide a base for stacking flanges 26, which will be discussed in more detail below. Moreover, as discussed throughout this disclosure, poultry cage 1 comprises a plurality of screws 46. In fact, each dark dot in FIG. 6 represents one screw 46. Because poultry cage 1 may be entirely assembled using screws 46, cage repair may be simplified, and cage costs may be reduced by using screws 46 rather than welds.

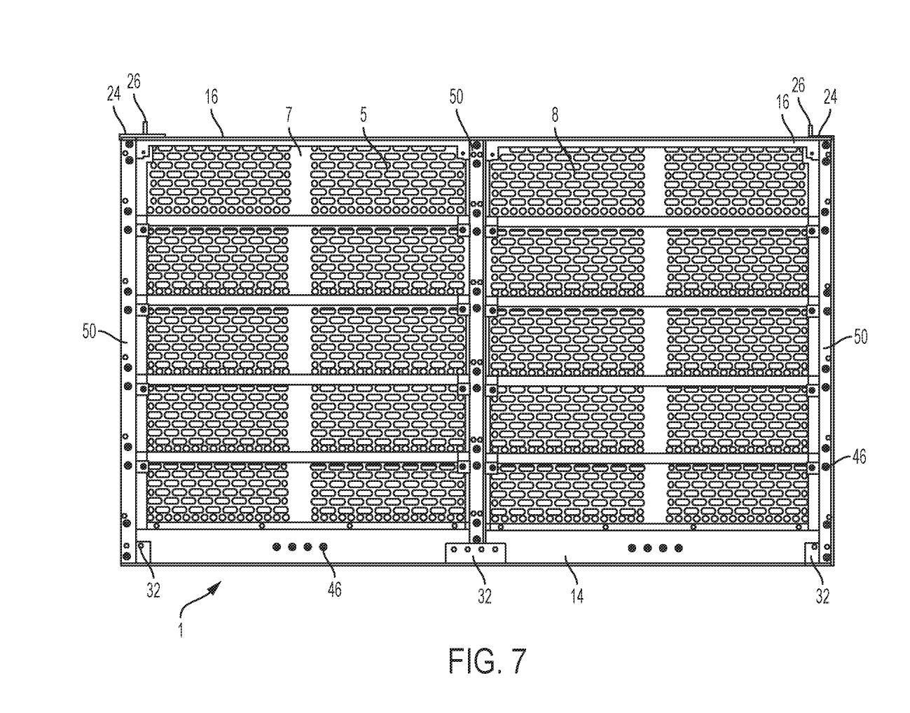

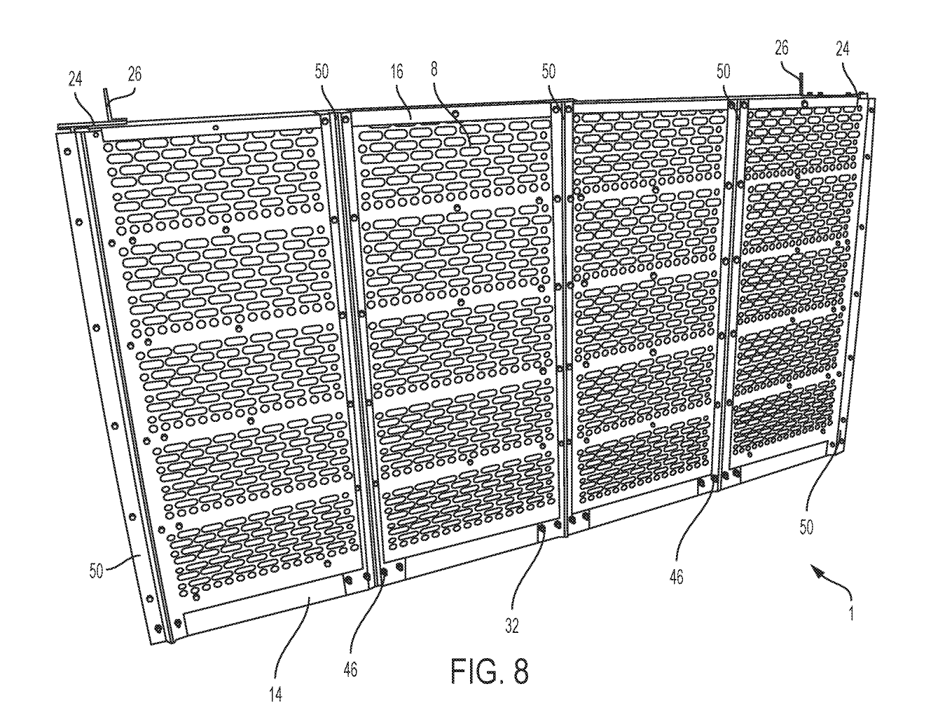

FIGS. 7 and 8 illustrate back views of poultry cage 1. As shown in FIGS. 7 and 8, back support members 50 may attach to one of two forklift receiving members 14 (FIG. 1) by screws via bottom attachment panels 32. In this regard, back support members 50 (only one shown in FIG. 7) may be firmly attached to poultry cage 1 and provide additional rigidity to back sheet 8. In addition, FIGS. 7 and 8 illustrate the stamped, perforated pattern of back sheet 8 (and similarly side sheets 4A, 4B and center sheet 6). As shown in FIGS. 7 and 8, back sheet 8 may comprise a patterned portion 5 and a solid portion 7. Solid portions 7 provide poultry cage 1 with additional surfaces for attachment to other cage components by the plurality of screws 46. Patterned portion 5 may primarily comprise a plurality of elongated elliptical holes (i.e., slots approximately two inches long by three-fourths of an inch high) and about one row of smaller circular holes (about one inch in diameter) at the bottom of each patterned portion 5, located at the bottom of each respective sub-cage volume, just above the sub-cage's floor pan 10. In this regard, patterned portion 5 may provide sufficient air flow through poultry cage 1 and the sub-cage volumes to provide air to chickens housed within the sub-cage volumes. However, patterned portion 5 comprises holes small enough such that patterned portion 5 prevents chickens from extending their wings through the holes or their feet through the smaller holes of the row of small circular holes at the bottom of each sub-cage volume. Also, while the holes allow patterned portion 5 to provide sufficient air flow to the chickens, their relatively small size results in sufficient aluminum webbing between the holes to block view from outside cage 1 into the sub-cage volumes to a sufficient extent so that individual bird forms within the sub-cages are not identifiable from outside cage 1. Moreover, the row of smaller circular holes at the bottom of each patterned portion 5 inhibit chickens from catching their feet in the holes when poultry cage 1 is tilted upon arrival at a processing facility as previously discussed.

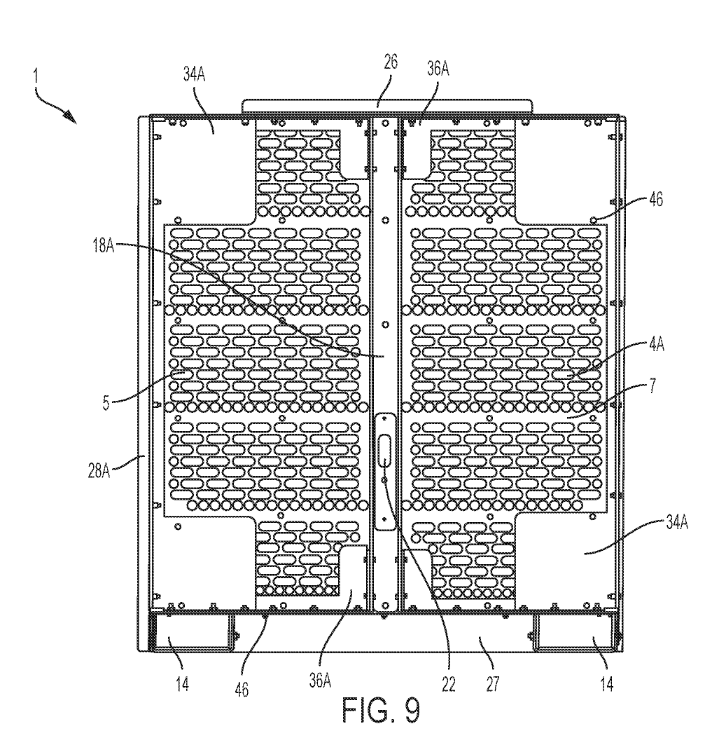

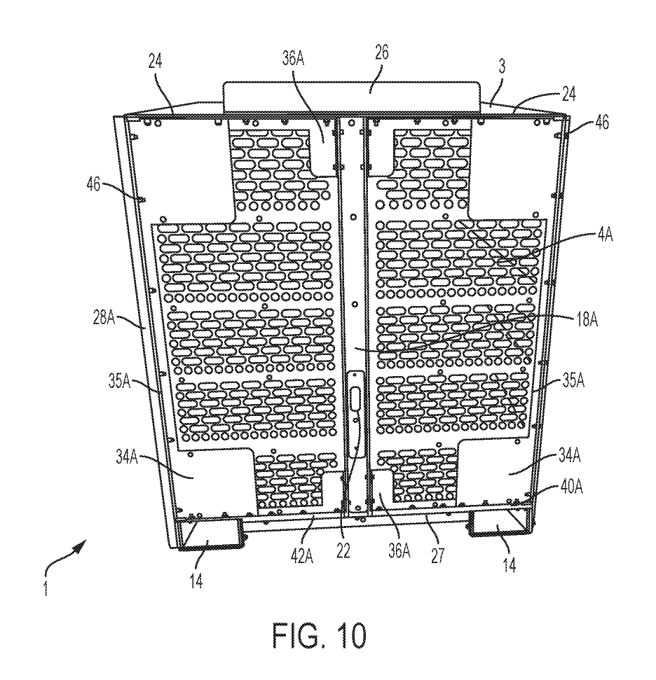

Poultry cage 1 may be designed to facilitate transport. As shown in FIGS. 9 and 10, for example, poultry cage 1 may comprise forklift receiving members 14, strap receiving members 22, stacking flanges 26, and stacking flange receiving members 27. Forklift receiving members 14 may be hollow rectangular structures extending the entire length of the longer side of cage 1. Each member 14 opens at both shorter sides of cage 1 so that members 14 can receive respective forklift prongs in order to lift, lower, and tilt poultry cage 1, from either short side of the cage. Moreover, stacking flanges 26 may be positioned on top sheet 3 on each of the shorter sides of poultry cage 1. Stacking flanges 26 may each extend vertically to a length of about one inch and laterally in parallel to the short cage sides. In this regard, stacking flanges 26 may be configured to fit inside stacking flange receiving members 27 when one poultry cage 1 is stacked on top of another. In particular, stacking flange receiving members 27 may comprise an aluminum sheet having about the same length as stacking flanges 26. Each receiving member 27 comprises a primary generally planar section disposed inward of its corresponding bottom side edge of cage 1 and extending parallel to that edge and between the two forklift receiving members 14 (perpendicular to the longitudinal axes of forklift receiving members 14). At each end of the planar main portion of receiving member 27, the receiving member bends 90°, so that a respective end flange extends from each side of the main planar portion toward the receiving member's corresponding short side of cage 1. Each side flange abuts a corresponding forklift receiving member 14 so that the side flanges can thereby be attached to the respective forklift receiving members 14 by screws extending through the side flanges and the forklift receiving members. When one cage 1 is stacked atop another cage 1, the two stacking flanges 26 at the top of the lower cage 1 extend upward just inward of respective receiving members 27, and generally abutting the receiving members 27, thereby locating the upper cage 1 in position atop the lower cage 1. As such, stacking flange receiving members 27 may be configured to securely receive stacking flanges 26 in order to stack poultry cages 1 for transport. In addition, each poultry cage may include a strap receiving member in each of its two side posts 18A, 18B that defines an oblong aperture 22 through the respective post to receive hooks at the ends of transport straps extending from and attached to opposing sides of a flatbed trailer to thereby secure a stack of poultry cages to the trailer. Specifically, in some example embodiments, only the top poultry cage 1 in a stack on a trailer is engaged by opposing straps, and the tension from the straps exerts a downward force on the stacked poultry cages 1, thereby holding all the poultry cages 1 vertically in place to the trailer. Blocks attached to the trailer may prevent longitudinal or lateral movement of a trailer stack on the trailer floor.

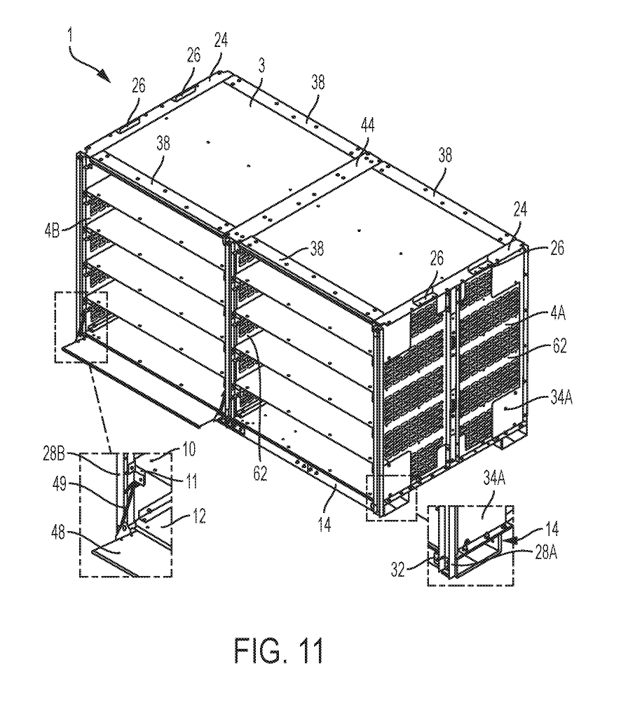

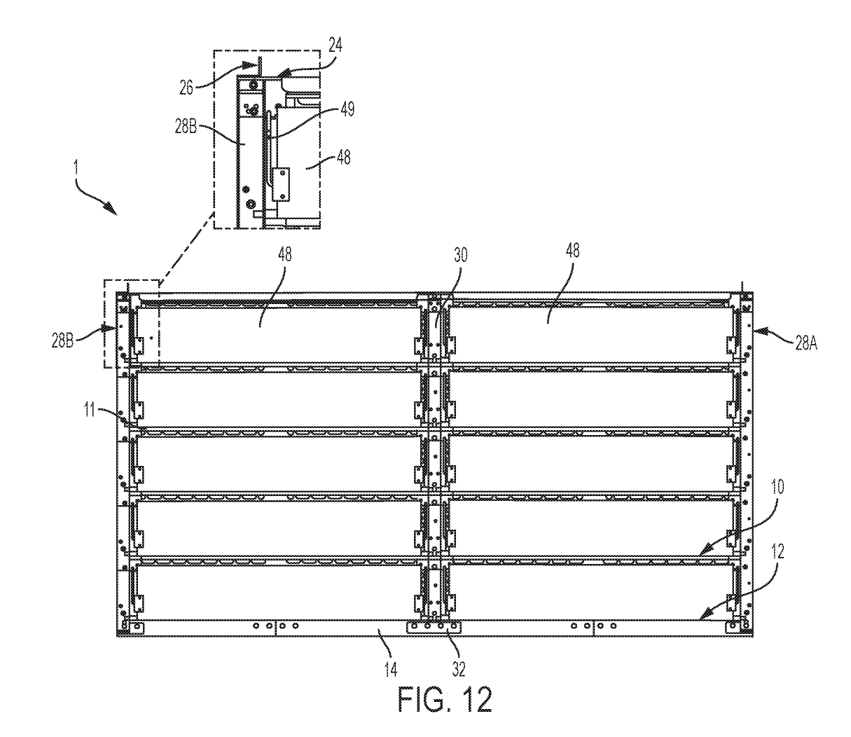

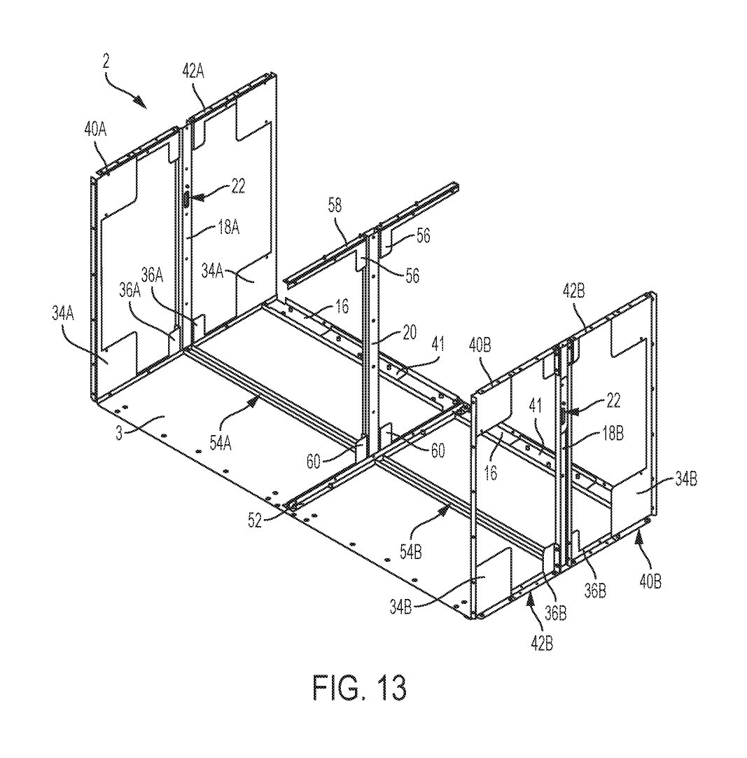

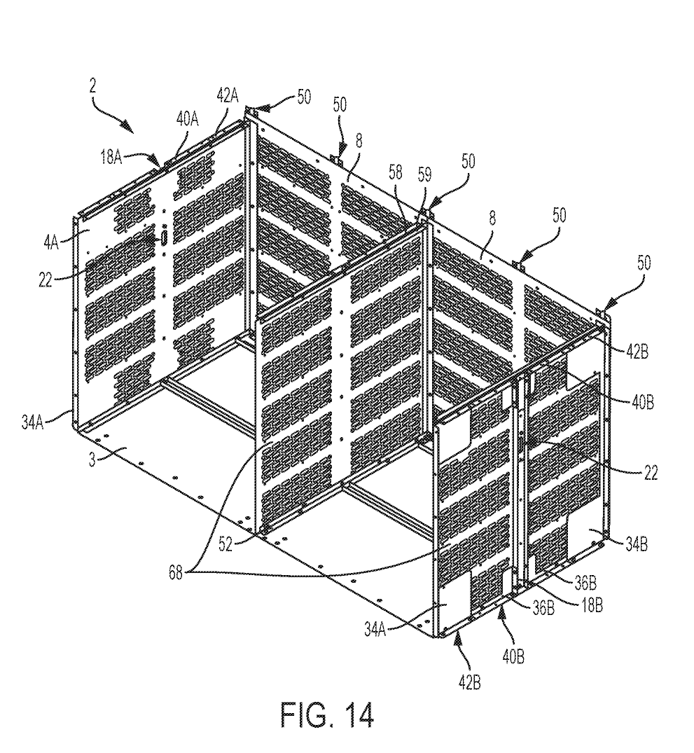

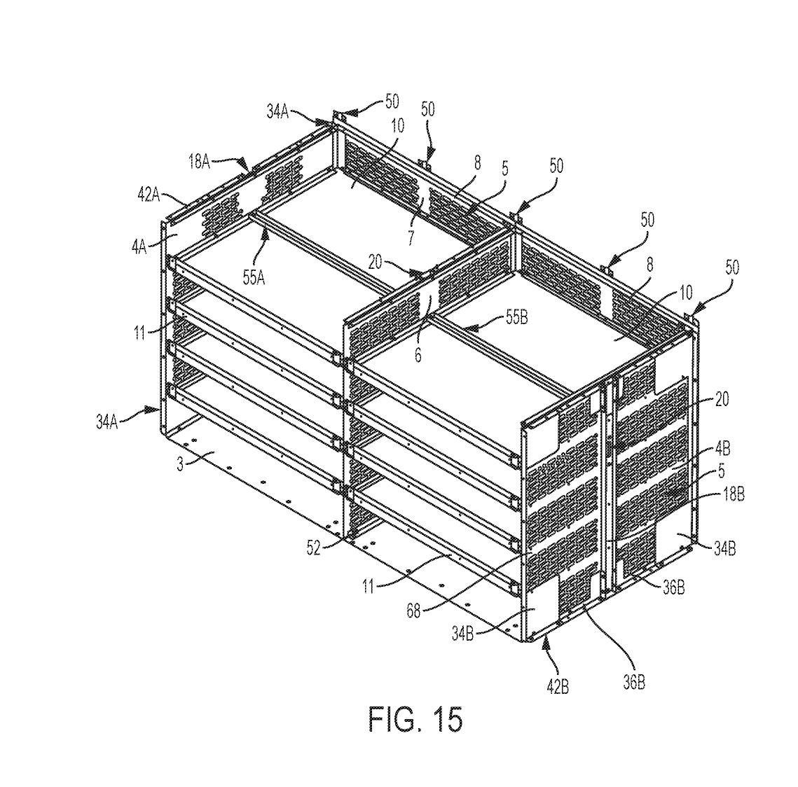

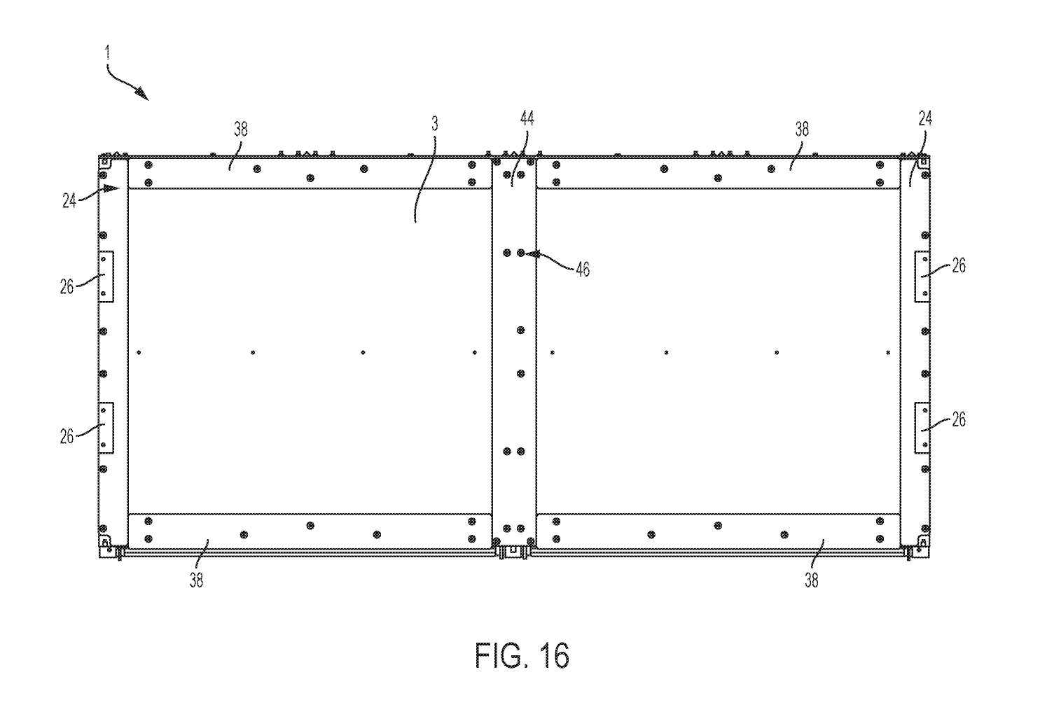

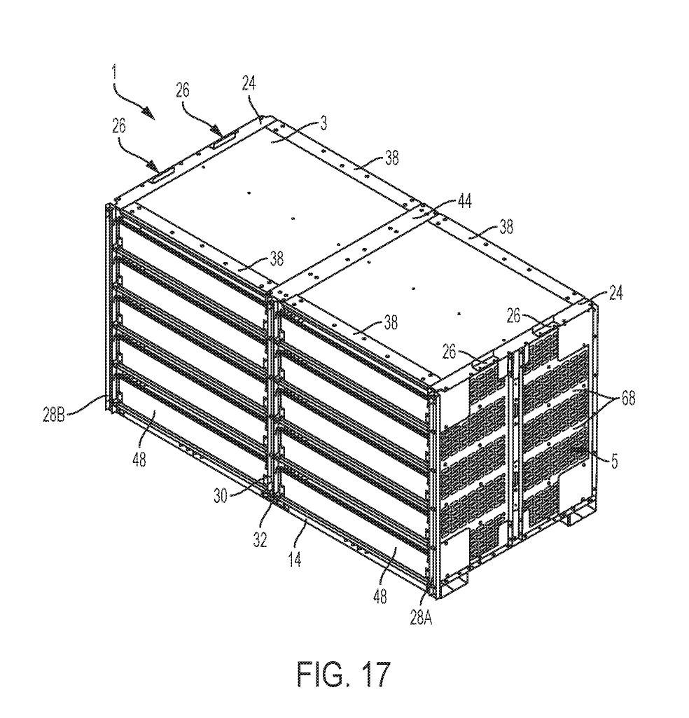

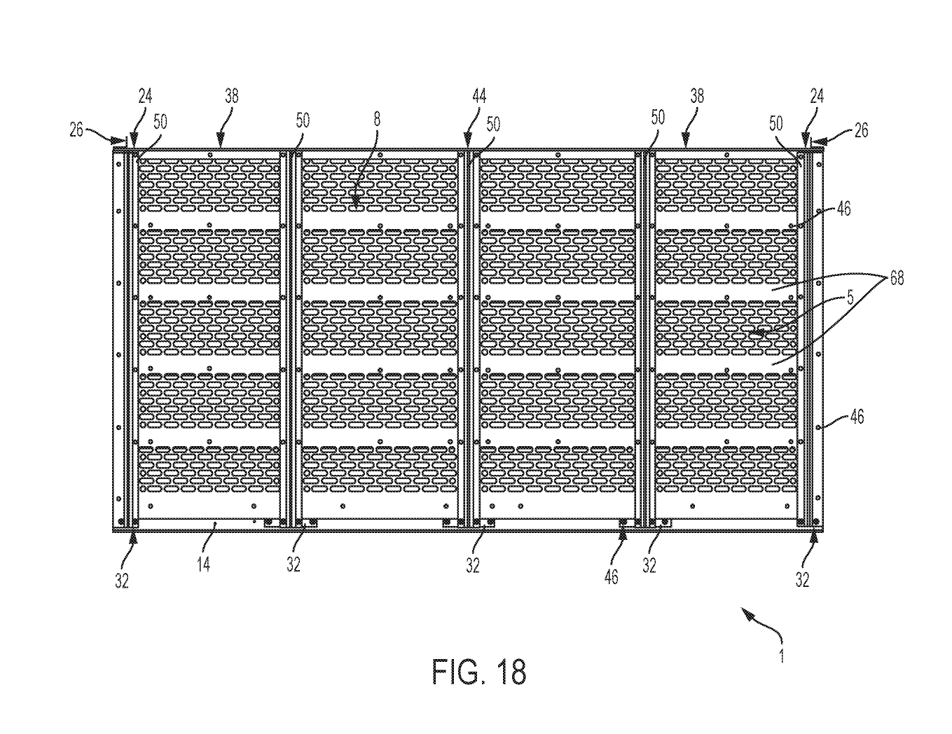

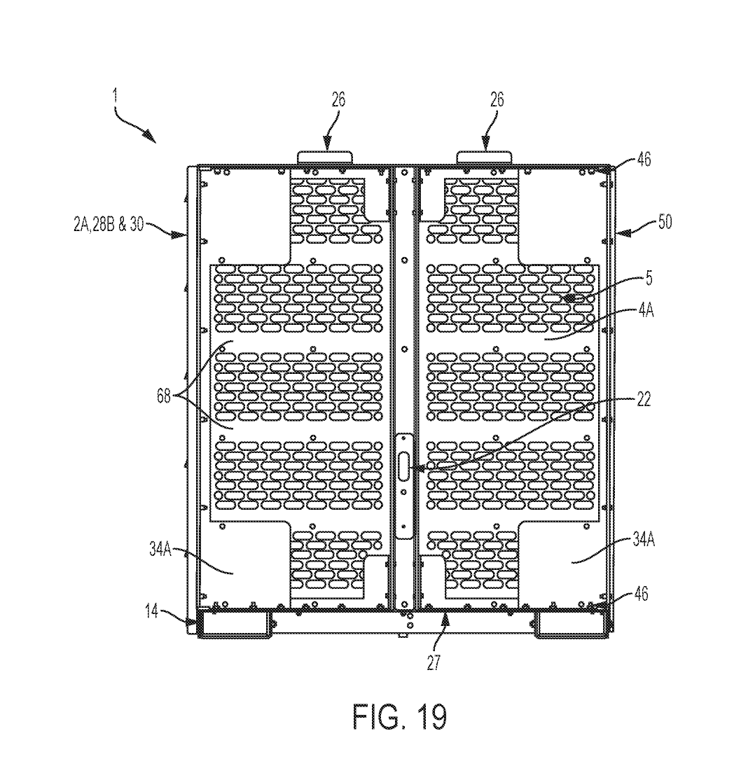

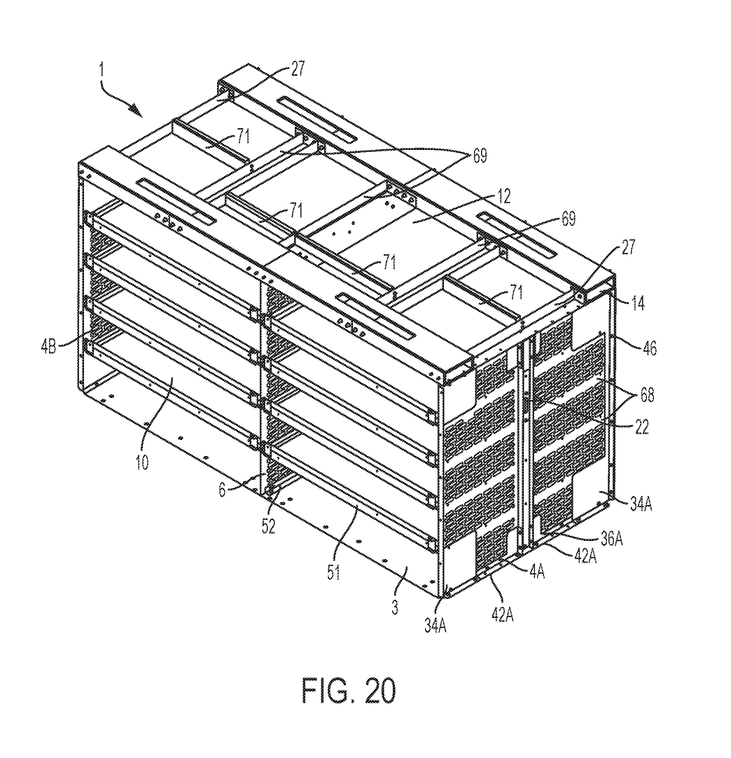

FIGS. 11-20 illustrate another embodiment in accordance with the present disclosure. FIG. 11 illustrates a top perspective view of a poultry cage with one bottom door 48 shown. FIG. 12 illustrates a front schematic view of a poultry cage with complete set of closed doors and detail of hinge according to an example embodiment. FIG. 13 illustrates a partial bottom perspective view of the poultry cage as in FIG. 11. FIG. 14 illustrates a partial bottom perspective view of the poultry cage as in FIG. 11. FIG. 15 illustrates a partial bottom perspective view of the poultry cage as in FIG. 11. FIG. 16 illustrates a top schematic view of the poultry cage as in FIG. 11. FIG. 17 illustrates a front perspective view of the poultry cage with a complete set of closed doors as in FIG. 11. FIG. 18 illustrates a back schematic view of the poultry cage as in FIG. 11. FIG. 19 illustrates a side schematic view of the poultry cage as in FIG. 11. FIG. 20 illustrates a bottom perspective view of the poultry cage as in FIG. 11.

Unless indicated herein and/or in the Figures, the construction of the embodiment of FIGS. 11-20 is similar to that of the embodiment of FIGS. 1-10. As shown in FIG. 11, cage 1 comprises side sheets 4A, 4B, center sheet 6, and back sheet 8 (FIG. 14), each such sheet comprising areas 62 without holes. Non-hole areas 62 are in some instances disposed near bottom floor pan 12 and intermediate floor pans 10 and may serve to prevent poultry hooking their feet in the sheets, particularly during unloading. In some embodiments, each non-hole area 62 may extend about two inches above the nearest bottom floor pan 12 or intermediate floor pan 10 and extend the entirety of a dimension, e.g. one of the four horizontal dimensions, of one or more of the sub-cages that is defined in part by the sheet that defines the area 62 and in which live poultry is disposed. As compared to the embodiment of FIGS. 1-10, the hole patterns in side sheets 4A, 4B, center sheet 6, and back sheet 8 of the embodiment of FIGS. 11-20 are the same, except that the rows of small circular holes in the FIGS. 1-10 embodiment are replaced by a continuously solid portion of area 62, i.e. with no through-holes capable of passing air therethrough, extending upward from the intersection of the particular sheet and the floor pan, or sheet, a predetermined distance, e.g., about two inches, sufficient to cover the area that the feet of poultry or other livestock housed with the sub-cages are expected to contact when the livestock slide out of the sub-cages.

As illustrated in FIG. 11, each door 48 may be pivotally attached to front corner posts 28A, 28B and front center post 30 by hinge pins or by separate hinges attached to the door and to horizontal ledges 51. In the former arrangement, for example, door 48 may have a bottom end rolled to create a loop. Pins, or one long rod, may extend from respective posts 28A, 28B, and 30 into the loop of door 48, thereby providing a pivot point or a single rod may extend between posts 28A/30 or 28B/30 and through both such loops at either end of the door. In further embodiments, door 48 may comprise flanges with holes, which serve as a pivot point in the same manner as the loops. Furthermore, as shown in FIG. 11, each door 48 may attach to floor pan attachment member 11 by way of wire strut 49, which holds door 48 in its 90° open position.

Embodiments of the present disclosure may implement various frame support types. For example, top support flanges 16, as illustrated in FIG. 13, are U-shaped channels rather than L-shaped members as shown in FIG. 3. Additionally, FIG. 16 illustrates alternate embodiments for top attachment panels 24, wherein flanges 26 attach to top attachment panels 24, rather than being fabricated from portions of panel 24 that are bent upward therefrom, as in the embodiment of FIGS. 1-10. As a result, top attachment panels 24 of the embodiment of FIGS. 11-20 are generally rectangular in shape, as seen in FIG. 16. Additionally, the embodiment of FIGS. 11-20, and particularly referring to FIG. 16, comprises generally rectangular top attachment panels 38 extending transversely between top attachment panels 24 and 46 on the front and back edges of the top of cage 1. Moreover, forklift receiving members 14 (shown as enclosed tubes of generally rectangular cross sections, but which may in further embodiments be in other configurations, such as, for example, U-shaped channels) may act as structural support members. Referring to FIGS. 20 and 13, forklift receiving members 14 attach to exterior side attachment flanges 40A, 40B, 42A and 42B bottom support flanges 58, and/or back support members 50 (FIGS. 14, 18, and 19). While forklift receiving members 14 are made of aluminum, stainless steel skid plates may be provided on the upper interior surfaces of the aluminum members to protect the members against the force applied by forklift prongs, particularly when only partially inserted into members 14 so that the prong ends make a primarily point contact with the upper inner member surfaces. Further, C-shaped stainless steel guards are placed around the outer edges of the forklift receiving members in some embodiments, also to protect the members from the forklift prongs. Elongated base support braces 69 attach to and extend between forklift receiving members 14, transversely to the elongation direction of members 14. Support braces 69 engage bottom sheet 12 to also provide further structural support to bottom floor pan 12, as shown in FIG. 20. Braces 71 attach to and extend between braces 69 and stacking flanges 27 to further stabilize cage 1 and also engage floor pan 12.

In some embodiments, portions of the frame may comprise stainless steel or other metal alloy components to further provide rigidity. Thus, in some embodiments, the entirety of frame 2 (FIGS. 3 and 13) may be made from aluminum, or made from stainless steel or other metal alloy, or may be made from a combination of aluminum, stainless steel, or other metal alloy. In the embodiment of FIGS. 11-20, and with particular reference to FIG. 13, for example, frame 2 is made entirely of aluminum, except for two U-shaped support members 41 shaped correspondingly to U-shaped support flanges 16 that are received within and attached to support flanges 16 as shown. Members 41 provide additional support for support flanges 16 against bending about the generally open front area of cage 1. In another embodiment, support flanges 16 are made of stainless steel. Further, referring to FIG. 16, one or more of panels 24, 38, and 44 may be made of stainless steel, to provide protection of the aluminum top sheet, and to provide additional strength, during cage stacking.

Various fasteners, e.g. screws, bolts, or rivets, may be used in the embodiments disclosed herein and may comprise protective coated steel and stainless steel or other suitable material. Fasteners may be implemented such that rivets are inserted on inside surfaces of cage 1, wherein the heads of the rivets are approximately flush with the inside surfaces, thereby minimizing catch points for poultry moving within the cage. Screws may be used for attaching exterior members, with the screws not extending into the interior of the cage, or only slightly extending, beyond inner cage surfaces in areas of the cage that house poultry, if desired, and provide a mechanism for easily disassembling the cage. In general, fasteners used in the cage assembly are installed so that sharp ends or edges of the fasteners do not extend into interior areas of the cage in which poultry or other livestock are disposed.

Example embodiments may provide lightweight aluminum poultry cages for transporting chickens having a cage frame, an aluminum top sheet, an aluminum bottom floor pan, at least two aluminum side sheets, an aluminum back sheet, an aluminum center sheet, and a plurality of aluminum intermediate floor pans. The cage frame (which may be made, e.g. from steel or aluminum), the aluminum top sheet, the aluminum bottom floor pan, the at least two aluminum side sheets, the aluminum back sheet, the aluminum center sheet, and the plurality of aluminum intermediate floor pans may be attached with a plurality of screws. In addition, the aluminum top sheet, the aluminum bottom floor pan, and the plurality of aluminum intermediate floor pans may comprise solid aluminum sheets. Moreover, the at least two aluminum side sheets, the aluminum back sheet, and the aluminum center sheet may comprise perforated patterned aluminum sheets. All the components described herein as being attached by screws should be understood as being removable and detachable with respect to each other, as opposed to being attached by welds or other attachment requiring destruction of the components for separation from each other. The removable/detachable attachment by screws thereby facilitates repair of the cage and/or its components.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A livestock cage comprising:
a frame;
a generally planar aluminum top sheet attached to the frame, thereby defining a top surface of the cage;
a generally planar aluminum bottom sheet attached to the frame opposite the top surface of the cage, thereby defining a bottom surface of the cage;
a first generally planar aluminum side sheet attached to the frame extending transverse to the top sheet from a first edge of the top sheet to a first edge of the bottom sheet, thereby defining a first side surface of the cage;
a second generally planar aluminum side sheet attached to the frame opposite the first side surface of the cage, thereby defining a second side surface of the cage, wherein front edges of the top sheet, the bottom sheet, the first side sheet, and the second side sheet define a front of the cage;
a generally planar back sheet attached to the frame opposite the front and transverse to the top sheet, the first side sheet, the second side sheet, and the bottom sheet, wherein the top sheet, the bottom sheet, the first side sheet, the second side sheet, the front, and the back sheet define an interior volume of the cage; and
a plurality of livestock within the interior of the cage,
wherein at least one of the first side sheet, the second side sheet, and the back sheet comprises a plurality of holes therethrough.

2. The cage of claim 1, wherein the livestock is poultry.

3. The cage of claim 2, wherein each hole has a major dimension not greater than about two inches and the plurality of holes being of sufficient size and number to facilitate sufficient air flow from an area external to the cage to the interior to maintain respiration of the poultry.

4. The cage of claim 3, wherein at least a portion of the plurality of holes comprises elongated elliptical holes.

5. The cage of claim 4, wherein the elongated elliptical holes have a major dimension of approximately two inches and a minor dimension of approximately three quarters of an inch.

6. The cage of claim 3, wherein the plurality of holes are arranged in a plurality of horizontal rows, and wherein holes in a row nearest the bottom floor sheet are generally circular with a diameter not greater than one inch.

7. The cage of claim 1, wherein the back sheet is aluminum.

8. The cage of claim 2, wherein the frame comprises at least one of the following: aluminum and stainless steel.

9. The cage of claim 2, wherein the frame is made entirely of aluminum.

10. The cage of claim 1, wherein the frame comprises a plurality of elongated members attached to at least one of the top sheet, the bottom sheet, the first side sheet, the second side sheet, and the back sheet, and wherein each of the elongated members is aluminum.

11. The cage of claim 10, wherein the frame is entirely aluminum.

12. The cage of claim 1, wherein at least one of the top sheet, the bottom sheet, the first aluminum side sheet, the second aluminum side sheet, and the back sheet comprises a plurality of discrete sections.

13. The cage of claim 1, further comprising a generally planar aluminum center sheet between the first side sheet of the cage and the second side sheet of the cage, transverse to the top sheet and the bottom sheet, wherein the center sheet comprises a plurality of holes therethrough configured to facilitate air flow.

14. The cage of claim 13, wherein at least a portion of the plurality of holes in the center sheet comprises elongated elliptical holes.

15. The cage of claim 14, wherein the elongated elliptical holes have a major diameter of approximately two inches and a minor diameter of approximately three quarters of an inch.

16. The cage of claim 13, wherein the plurality of holes in the center sheet comprises a plurality of holes located within two inches of the bottom floor sheet, and each hole of the plurality of holes within two inches of the bottom of the floor sheet has a major diameter not greater than about one inch.

17. The cage of claim 1, further comprising at least one intermediate floor sheet between the top surface of the cage and the bottom surface of the cage, and transverse to the first side sheet, the second side sheet, and the back sheet so that the intermediate floor sheet, the back sheet, and at least one of the first side sheet and the second side sheet define part of a sub-enclosure within the interior.

18. The cage of claim 13, wherein each hole of the plurality of holes in the center sheet within two inches above the at least one intermediate sheet has a major dimension not greater than one inch.

19. The cage of claim 17, wherein the plurality of holes are located entirely outside respective areas of the at least one of the first side sheet, the second side sheet, and the back sheet extending at least about two inches above the bottom floor sheet and above the at least one intermediate floor sheet, wherein the respective areas are without through-holes capable of passing air therethrough and wherein each respective area extends an entire dimension of an enclosure within the interior volume within which live poultry are disposed.

20. The cage of claim 17, further comprising a plurality of doors hingedly attached at the front of the cage respectively proximate to at least one of the bottom sheet and the at least one intermediate sheet, and a respective spring-biased detent fixed to the frame proximate an opening for each door and configured to retain the door in a closed position in which the door encloses at least a portion of the interior volume.

21. The cage of claim 20, wherein the spring-bias of the detent is configured so that a predetermined force applied to the door when in the closed position overcomes the spring-bias of the detent to release the detent and thereby allow the door to pivotally move to an open position, in which the door does not enclose the at least a portion of the interior volume, in response to the force.

22. A livestock cage comprising:
a frame;
a generally planar aluminum top sheet attached to the frame, thereby defining a top surface of the cage;
a generally planar aluminum bottom sheet attached to the frame opposite the top surface of the cage via a plurality of rivets so that a head of each rivet is approximately flush with a top surface of the bottom sheet, thereby defining a bottom surface of the cage;
a first generally planar aluminum side sheet attached to the frame extending transverse to the top sheet from a first edge of the top sheet to a first edge of the bottom sheet, thereby defining a first side surface of the cage;
a second generally planar aluminum side sheet, attached to the frame opposite the first side surface of the cage, thereby defining a second side surface of the cage, wherein front edges of the top sheet, the bottom sheet, the first side sheet, and the second side sheet define a front of the cage;
a generally planar back sheet attached to the frame opposite the front and transverse to the top sheet, the first side sheet, the second side sheet, and the bottom sheet, wherein the top sheet, the bottom sheet, the first side sheet, the second side sheet, the front, and the back sheet define an interior volume of the cage; and
a plurality of livestock within the interior of the cage,
wherein at least one of the first side sheet, the second side sheet, and the back sheet comprises a plurality of holes therethrough.

23. The cage of claim 22, wherein the livestock is poultry.

24. The cage of claim 22, further comprising at least one intermediate floor sheet between the top surface of the cage and the bottom surface of the cage and transverse to the first side sheet, the second side sheet, and the back sheet, attached to the frame via rivets so that the head of the rivet is approximately flush with a top surface of the at least one intermediate floor sheet.

25. The cage of claim 24, wherein at least one of the bottom floor sheet and the at least one intermediate floor sheet comprises at least one flange at an edge thereof bent towards a bottom of the cage for providing a location for attaching.
